(19) United States
(12) Patent Application Publication
(10) Pub. No.: US 2007/0222134 A1
(43) Pub. Date: Sep. 27, 2007

(54) Roller apparatus for sheet folding machine

(76) Inventors: Eiji Katayama, Shiga (JP); Hiroki Yamamoto, Shiga (JP); Tatsuaki Ida, Shiga (JP); Takehito Yokogi, Shiga (JP)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 11/726,955

(22) Filed: Mar. 23, 2007

(30) Foreign Application Priority Data
Mar. 24, 2006 (JP) 2006-082376

(51) Int. Cl. B41L 43/04

(52) U.S. Cl. 270/41

(57) ABSTRACT

There are provided a pair of rollers (W, W1; W, W2; W2, W3; W3, W4) for taking a sheet in a buckle zones (b1-b4), and a pair of rollers (W, W2; W2, W3; W3, W4; W4, W5) for folding a portion of the sheet deflecting from the buckle zones (b1-b4). A rotating shaft of at least one of the rollers of each of the roller pairs is carried by one end of a lever (6). The lever (6) is arranged for swing around a supporting point (8), and the other end of the lever (6) is provided with a spring resiliently biasing the roller carried by the lever (6) in a direction in which the roller is pressed against the counter roller. One end of an adjustment rod (15a-15e) is brought into contact with the other end of the lever (6). The adjustment rod (15a-15e) is guided by a guide (14) in a direction of its axis. The other end of the adjustment rod (15a-15e) is provided with a pulse motor (M1-M5) moving the adjustment rod (15a-15e) through the guide (14). The pulse motor (M1-M5)is driven, whereby the adjustment rod (15a-15e) is moved so as to swing the lever (6), and the gap length between the opposed rollers is adjusted.

### BACKGROUND OF THE INVENTION

1. Field of the Invention

The present invention relates to a roller apparatus incorporated into a sheet folding machine.

2. Description of the Related Art

FIG. 5 is a view illustrating a schematic structure of a conventional sheet folding machine. In FIG. 5, the letter A denotes a sheet feeding section, the letter B denotes a sheet conveying section, and the letter C denotes a sheet folding section. The sheet feeding section A has a sheet supply table 1 arranged for up-and-down motion and supporting a sheet bundle thereon, and a roller 2 for feeding the uppermost sheet P of the sheet bundle placed on the sheet supply table 1, and the sheet feeding section A feeds the uppermost P of the sheet bundle to the sheet conveying section B one by one. The sheet conveying section B has a conveyor belt 3 conveying the sheet P supplied from the sheet feeding section A to the sheet folding section C, and a group of rollers 4 preventing the sheet P from lifting from the conveyor belt 3.

The sheet folding section C comprises a fixed roller W whose position is fixed, a plurality of movable rollers W1 to W5 whose positions are adjustable, and a plurality of buckles b1 to b4 provided with position adjustable stoppers S1 to S4. Near an inlet of the buckle b1, there are provided a pair of the fixed roller W and the movable roller W1 which are arranged oppositely to each other, and a pair of the fixed roller and the movable roller W2 which are arranged oppositely to each other. Further near an inlet of the buckle b2, there are provided a pair of the fixed roller W and the movable roller W2 which are arranged oppositely to each other, and a pair of the movable roller W2 and the movable roller W3 which are arranged oppositely to each other. Near an inlet of the buckle b3, there are provided a pair of the movable roller W2 and the movable roller W3 which are arranged oppositely to each other, and a pair of the movable roller W3 and the movable roller W4 which are arranged oppositely to each other. Near an inlet of the buckle b4, there are provided a pair of the movable roller W3 and the movable roller W4 which are arranged oppositely to each other, and a pair of the movable roller W4 and the movable roller W5 which are arranged oppositely to each other.

When a sheet folding operation is executed, each of the stoppers S1 to S4 is fixed to a position corresponding to a folding position of the sheet. Then the sheet P fed from the sheet conveying section B is nipped between the fixed roller W and the movable roller W1, and a leading end of the sheet P is introduced into the buckle b1. When the leading end of the sheet P is brought into contact with the stopper S1 of the buckle b1, the remaining portion of the sheet P is deflected from the buckle b1, the deflected portion is nipped between the movable roller W2 and the fixed roller W, and the sheet P is folded.

In a case where the sheet P is further folded, the sheet P is further introduced into the buckle b2 with the fold line in the lead. When the leading end (the fold line) of the sheet P is brought into contact with the stopper S2, the remaining portion of the sheet P is deflected from the buckle b2, the deflected portion is nipped between the movable roller W2 and the movable roller W3, and the sheet P is folded. As mentioned above, the sheet P is folded at two times. In the same manner as mentioned above, after the sheet P is folded by the movable roller W2, the movable roller W3 and the movable roller W4, and the buckle b3, and further by the movable roller W3, the movable roller W4 and the movable roller W5, and the buckle b4, sequentially, the sheet is discharged from the apparatus.

In this case, in order to sequentially fold the sheet P, it is necessary to adjust a gap between the opposed rollers in correspondence with a thickness of the sheet P nipped therebetween. For example, if the gap length between the fixed roller W and the movable roller W1 corresponds to the thickness of a sheet, it is necessary to adjust a gap length between the fixed roller W and the movable roller W2 in correspondence with a thickness of two sheets.

Accordingly, as shown in FIG. 6, for example, in the fixed roller W and the movable roller W1, a rotating shaft 5 of the movable roller W1 is carried by one end of an arm 6 arranged for swing around a supporting point 8 provided at the intermediate portion thereof, and the other end of the arm 6 is resiliently biased by a tension spring 7 in a direction in which the movable roller W1 is pressed against the counter roller W. An adjustment screw shaft 9 is coupled to the arm 6 for defining the closest position of the movable roller W1 with respect to the fixed roller W, and an adjustment knob 11 is fixed to one end of the adjusting screw shaft 9. A position detector S including a potentiometer is attached to the other end of the adjusting screw shaft 9. The adjustment knob 11 is provided with a scale 10, and the adjustment screw shaft 9 rotates by manually rotating the adjustment knob 11 so that the arm 6 swings around the supporting point 8. A spindle 12 having a thread is arranged in parallel to the adjustment screw shaft 9 and coupled to the adjustment screw shaft 9 through a pinion mechanism 13. The spindle 12 is further coupled to a direct-current motor M, whereby the rotation of the spindle 12 is transmitted to the adjustment screw shaft 9. Accordingly, the gap between the fixed roller W and the movable roller W1 can be adjusted based on the rotation of the motor M and the rotation of the adjusting knob 11. With regard to each of the movable rollers W2 to W5, the same gap adjusting mechanism as the movable roller W1 is provided.

Furthermore, the gap between the opposed rollers is adjusted by controlling the motor M provided for each of the movable rollers W1 to W5, and the gap length is finely adjusted by manually rotating the adjusting screw 1, thereby being adapted to the thickness of the sheet to be folded. A value of the position detector S at a time when the adjustment is finished is stored in a CPU, and the gap between the rollers is automatically adjusted during the operation of the sheet folding machine by comparing the stored value with a current value of the position detector S.

As mentioned above, in the conventional mechanism of adjusting the gap between the rollers, it is necessary for an operator to show up at the position of the adjustment knob for each of the movable rollers and manually rotate the adjustment knob so as to execute fine adjustment. There is caused a problem that this work is troublesome and it takes a long time for the work. In addition, it is necessary to arrange the potentiometer for each of the movable rollers, and there is caused a problem that the apparatus becomes very expensive.

### SUMMARY OF THE INVENTION

Accordingly, it is an object of the present invention to simplify a mechanism for adjusting a gap between the opposed rollers in a roller apparatus for a sheet folding machine, and to simply execute an operation for adjusting the gap length between the rollers.

In order to achieve the object, in accordance with the present invention, there is provided a roller apparatus for a sheet folding machine having: at least one buckle zone in which a sheet to be folded is introduced by a length corresponding to a predetermined fold position; a pair of rotatably driven rollers arranged near an inlet of the buckle zone(s) and oppositely to each other for taking the sheet in the buckle zone(s); a pair of rotationally driven rollers arranged near the inlet of the buckle zone(s) and oppositely to each other for folding a portion of the sheet deflecting from the buckle zone(s); a rotating shaft of at least one of the rollers of each of the roller pairs being carried by one end of a lever, the lever being arranged for swing around a supporting point provided at its intermediate position, the other end of the lever being provided with a spring resiliently biasing the roller carried by the lever in a direction in which the roller is pressed against the counter roller, the lever being provided with a roller gap adjusting means for adjusting a gap between the rollers for each of the roller pairs by setting the closest position of the roller carried by the lever to the counter roller, the roller apparatus characterized in that the roller gap adjusting means comprises: an adjustment rod one end of which is brought into contact with the other end of the lever or is pivotally connected to the other end of the lever through a pivot; a guide for guiding the adjustment rod in a direction of the axis thereof; a pulse motor connected to the other end of the adjustment rod so as to move the adjustment rod through the guide, the lever being rotated around the supporting point by rotary drive of the pulse motor; an input means for inputting a preset value of a gap length between the rollers for each of the roller pairs; a storage means for storing the preset value inputted from the input means; and a control means sending a control signal to the associated pulse motor so as to drive the pulse motor based on the preset value stored in the storage means, whereby, for each of the roller pairs, the pulse motor is driven by the control means, the adjustment rod is moved so as to swing the lever and the gap length between the opposed rollers is adjusted.

In accordance with a preferable embodiment of the present invention, the input means comprises a touch panel display, and a screen of the touch panel display is provided with a selector button for selecting a roller gap to be adjusted, and a preset value input button for inputting or changing a preset value of the length of the roller gap selected by the selector button.

In accordance with the other embodiment of the present invention, the roller apparatus further comprises another input means arranged separately from the roller apparatus and the another input means is connected to the control means, the storage means and the input means of the roller apparatus for data communication, and the information about the roller gap selected by the another input means and the preset value of the gap length of the roller gap inputted from the another input means are directly transmitted to the storage means and the input means.

According to the present invention, the gap length between the rollers of each of the roller pairs arranged near the inlet of the buckle zone can be independently changed by the movement of the adjustment rod based on the rotary drive of the pulse motor, and the gap between the opposed rollers can be adjusted by only inputting the preset value of the gap length so as to drive the pulse motor by the amount of rotation corresponding to the preset value, so that the adjusting mechanism of the gap length between the opposed rollers can be simplified and the operation of roller gap adjustment is facilitated. In addition, it is possible to simply execute the adjustment of the roller gap for a short time by concentrating the input section for the preset value of the length of the roller gap to one position.

### BRIEF DESCRIPTION OF THE DRAWINGS

FIG. 1 is a Side elevational view illustrating a structure of a main part of a roller apparatus for a sheet folding machine in accordance with a first embodiment of the present invention;

FIG. 2 is a block diagram illustrating a structure of a control section of the roller apparatus shown in FIG. 1;

FIG. 3 is a view illustrating a display screen of a display of the roller apparatus shown in FIG. 1;

FIG. 4 is a perspective view illustrating a whole of the sheet folding machine in accordance with the first embodiment of the present invention;

FIG. 5 is a schematic view illustrating a structure of a conventional sheet folding machine; and

FIG. 6 is a schematic view illustrating a structure of a mechanism for adjusting a gap length between rollers of a roller apparatus for the sheet folding machine shown in FIG. 5.

### DETAILED EXPLANATION OF THE PREFERRED EMBODIMENTS

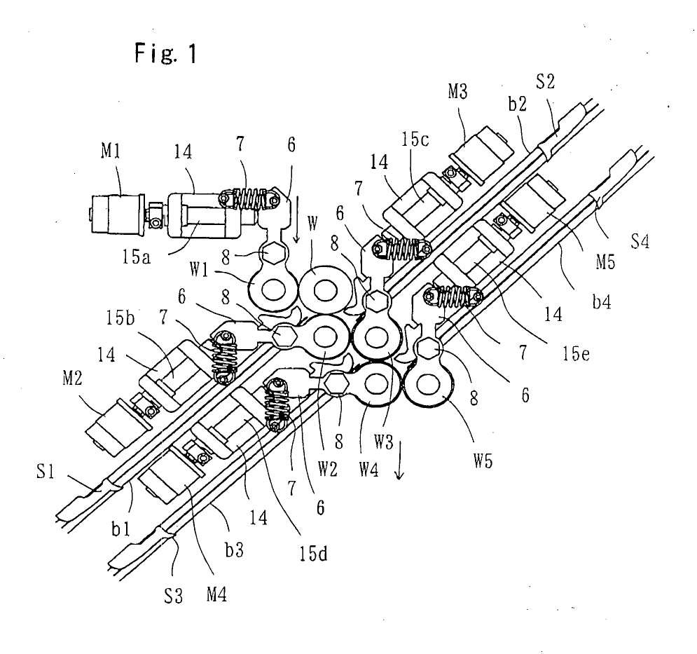

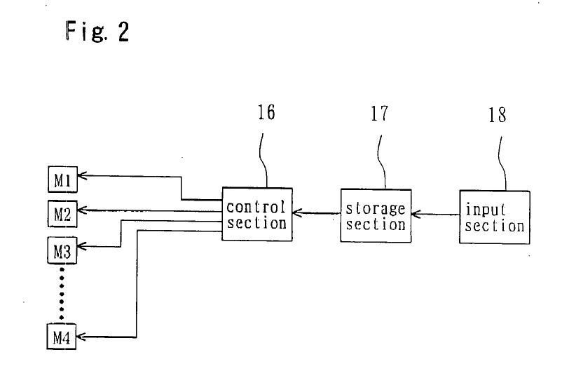

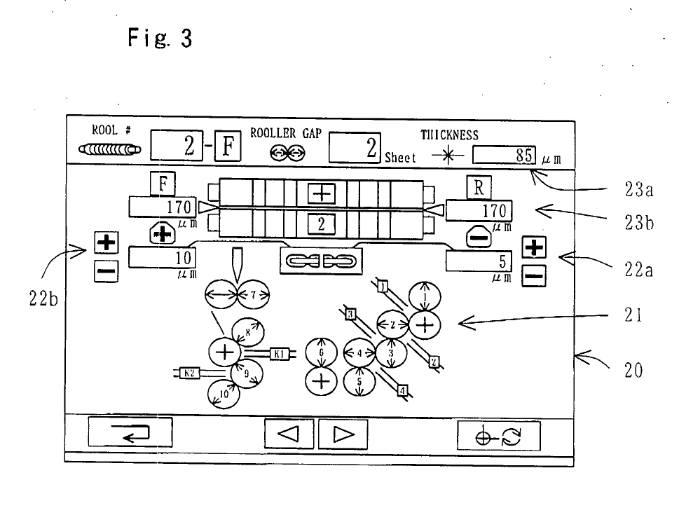

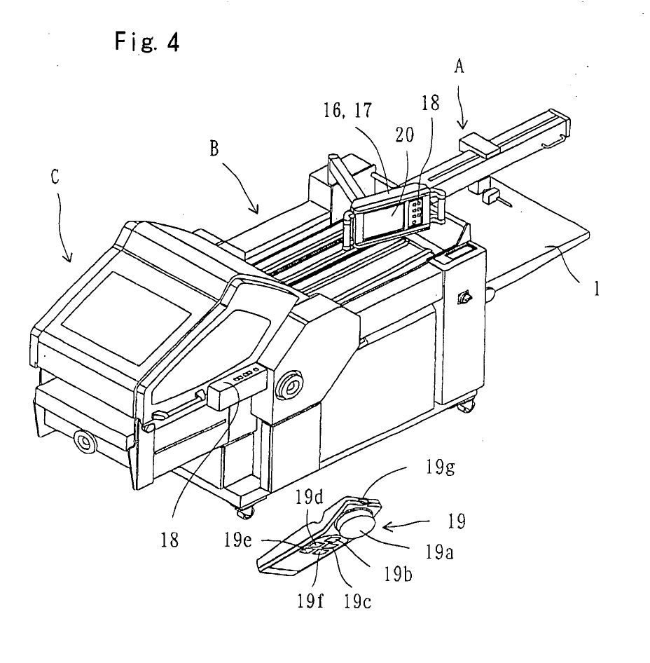

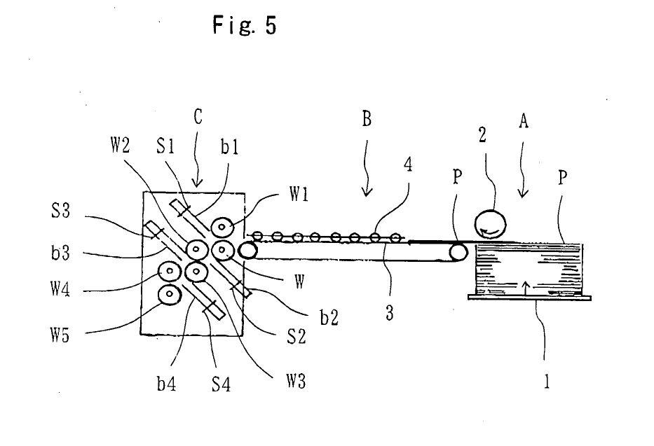

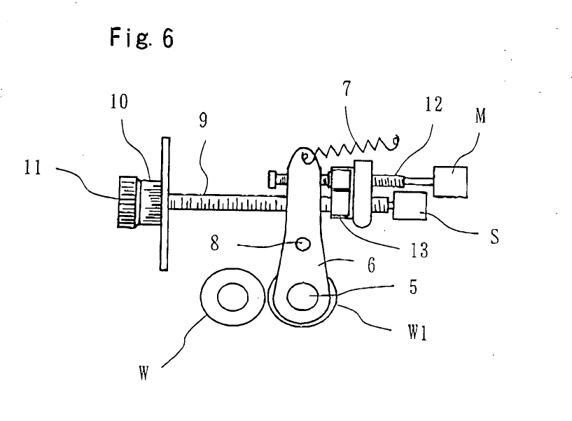

A explanation of a preferable embodiment according to the present invention will be given below with reference to the accompanying drawings. FIG. 1 is a side elevational view illustrating a structure of a main part of a roller apparatus for a sheet folding machine according to a first embodiment of the present invention FIG. 2 is a block diagram illustrating a structure of a control section of the roller apparatus shown in FIG. 1, FIG. 3 is a view illustrating a display screen of a display of the roller apparatus shown in FIG. 1, and FIG. 4 is a perspective view illustrating a whole of the sheet folding machine in accordance with the first embodiment of the present invention. In FIGS. 1 to 4, the same reference numerals are attached to corresponding constituting elements to the constituting elements shown in FIGS. 5 and 6.

Referring to FIG. 1, the letters b1 to b4 denote a buckle zone in which a sheet to be folded is inserted by the length corresponding to a predetermined folding position. A pair of rotating rollers are arranged near an inlet of each of the buckle zones b1 to b4 and oppositely to each other for taking the sheet in the buckle zones b1 to b4, and a pair of rotating rollers are arranged near an inlet of each of the buckle zones b1 to b4 and oppositely to each other for folding a portion of the sheet deflecting from the buckle zones b1 to b4. In other words, a fixed roller W whose position is fixed and a movable roller W1 whose position is adjustable are arranged near an inlet of the buckle zone b1 and oppositely to each other, and the fixed roller W and a movable roller W2 whose position is adjustable are arranged near the inlet of the buckle zone b1 and oppositely to each other. Further, the fixed roller W and the movable roller W2 are arranged near an inlet of the buckle zone b2 and oppositely to each other, and the movable roller W2 and a movable roller W3 whose position is adjustable are arranged near the inlet of the buckle zone b2 and oppositely to each other. Further, the movable roller W2 and the movable roller W3 are arranged near an inlet of the buckle zone b3 and oppositely to each other, and the movable roller W3 and a movable roller W4 whose position is adjustable are arranged near the inlet of the buckle zone b3 and oppositely to each other. Further, the movable roller W3 and the movable roller W4 are arranged near an inlet of the buckle zone b4 and oppositely to each other, and the movable roller W4 and a movable roller W5 whose position is adjustable are arranged near the inlet of the buckle zone b4 and oppositely to each other.

Stoppers S1 to S4 are provided in the respective buckle zones b1 to b4 in such a manner that a position of each of the stopper S1 to S4 is adjustable for determining a length of the sheet to be inserted into the buckle zone b1 to b4, that is, a folding position of the sheet.

A rotating shaft of each of the movable rollers W1 to W5 is carried by one end of a levers 6, and each of the levers 6 is arranged for swing around a supporting point 8 provided at its intermediate position. One end of a tension spring 7 is attached to the other end of each of the levers 6, and the other end of the tension spring 7 is attached to a guide member 14 fixed to a frame (not shown). The tension spring 7 has function of resiliently biasing the roller supported by the associated lever 6 in a direction in which the roller is pressed against the counter roller. In other words, the lovable rollers W1 and W2 are resiliently biased in a direction in which they are pressed against the fixed roller W by these tension springs 7, the movable roller W3 is resiliently biased in a direction in which it is pressed against the movable roller W2, the movable roller W4 is resiliently biased in a direction in which it is pressed against the movable roller W3, and the movable roller W5 is resiliently biased in a direction in which it is pressed against the movable roller W4.

Furthermore, each of the levers 6 is provided with a roller gap adjusting means for adjusting a gap between the rollers for each of the roller pairs by setting the closest position of the roller carried by the lever 6 to the counter roller.

In this embodiment, the roller gap adjusting means comprises adjustment rods 15a to 15e one end of each of which is brought into contact with the other end of the lever 6, guide members 14 for guiding the adjustment rods 15a to 15e in a direction of the axis thereof, and pulse motors M1 to M5 with speed changer connected to the other end of the adjustment rods 15a to 15e so as to move the adjustment rods 15a to 15e through the guide members 14. Accordingly, when the adjustment rod 15a to 15e is moved toward the lever 6 based on the rotary drive of the pulse motor M1 to M5, the lever 6 swings around the supporting point 8 against the resilient force of the tension spring 7, and on the contrary, when the adjustment rod 15a to 15e is moved away from the lever 6, the lever 6 swing around the supporting points 8 by the resilient force of the tension spring 7. In this embodiment, one end of each of the adjustment rods 15a to 15e is brought into contact with the other end of the lever 6, however, one end of each of the adjustment rods 15a to 15e may be pivotally connected to the other end of the lever 6 through a pivot.

As mentioned above, an amount of movement of each of the adjustment rods 15a to 15e is adjusted based on the control of an amount of rotation of each of the pulse motors M1 to M5, whereby it is possible to individually adjust the gap between the opposed rollers, that is, the gap between the fixed roller W and the movable roller W1, the gap between the fixed roller W and the movable roller W2, the gap between the movable roller W2 and the movable roller W3, the gap between the movable roller W3 and the movable roller W4, and the gap between the movable roller W4 and the movable roller W5, in correspondence with the thickness of the sheet sequentially folded.

As shown in FIG. 2, the roller gap adjusting means further comprises an input section 18 for inputting a preset value of the gap length between the rollers of each of the roller pairs, a storage section 17 storing the preset value inputted from the input section 18, and a control section 16 sending a control signal to the associated pulse motor M1 to M5 so as to drive the pulse motor M1 to M5 based on the preset value stored in the storage section 17. The control section 16 converts the preset value into the pulse number and sequentially controls the pulse motors M1 to M5.

In this embodiment, the input section 18 has a touch panel display 20, and a screen of the touch panel display 20 is provided with a selector button 21 for selecting a roller gap to be adjusted, and a preset value input button 22a, 22b for inputting or changing a preset value of the length of the roller gap selected by said selector button 21. In this case, in the selector buttons 21, a round mark having a character + in its center corresponds to a button for selecting the fixed roller W, a round mark having a character 1 in its center corresponds to a button for selecting the movable roller W1, a round mark having a character 2 in its center corresponds to a button for selecting the movable roller W2, and the like. The preset value input button 22a corresponds to a button for setting a decreasing amount in a case of decreasing the preset value, and the preset value input button 22b corresponds to a button for setting an increasing amount in a case of increasing the preset value.

Furthermore, there are provided regions 23a and 23b for displaying the selected roller pair and the current value of the gap length between the selected roller pair. In FIG. 3, the display regions 23a and 23b display the fact that the selected roller pair is a pair of the fixed roller W and the movable roller W2, and the current value of the gap length therebetween.

In addition, the input section 18 is provided with operation buttons such as a start button for starting the operation of the sheet folding machine, a stop button for stopping the operation, a test button for test run of the sheet folding machine, and the like.

In this embodiment, a remote control unit 19 is arranged separately from the roller apparatus for the sheet folding machine. The remote control unit 19 is connected to the roller apparatus for data communication through an infrared ray. The remote control unit 19 is provided with a dial 19a for setting the preset value of the gap length between the opposed rollers, a selector button 19b for selecting the opposed rollers to be adjusted the gap length thereof, a start button 19c for starting the operation of the sheet folding machine, a stop button 19d for stopping the operation, a test button 19e for test run of the sheet folding machine, a screen switching button 19f for switching the screen of the touch panel display 20, and an infrared ray transmitter 19g transmitting the control signal and the data to the control section 16, the storage section 17 and the input section 18 of the roller apparatus in correspondence with the operations of these buttons.

Accordingly, a thickness of the sheet to be folded is measured prior to the operation of the sheet folding machine, and the preset value of the gap length between the opposed rollers is inputted through the touch panel display 20 or the remote control unit 19 in such a manner that the gap length corresponds to the thickness of the sheet or the thickness at a time when the sheet is folded once, twice or the like, and is stored in the storage section 17. Further, the test button and the start button of the input section 18 are operated, and it is possible to observe whether or not the sheet smoothly passes through the gap length between the rollers on schedule so as to be folded. In the process of the observation, the defective rollers are selected by the touch panel display 20 or the remote control unit 19, the preset value of the gap length is suitably adjusted so as to be increased or decreased, and the new preset value after being adjusted is stored in the storage section 17. At this time, the operator can easily work while viewing the touch pane display 20 at the observing position. After the adjusting work is finished, the start button is operated, and the operation of the sheet folding machine is started.

What is claimed is:

1. A roller apparatus for a sheet folding machine having:
at least one buckle zone (b1-b4) in which a sheet to be folded is introduced by a length corresponding to a predetermined fold position;
a pair of rotating rollers (W, W1; W, W2; W2, W3; W3, W4) arranged near an inlet of said buckle zone(s) (b1-b4) and oppositely to each other for taking the sheet in said buckle zone(s) (b1-b4);
a pair of rotating rollers (W, W2; W2, W3; W3, W4; W4, W5) arranged near the inlet of said buckle zone(s) (b1-b4) and oppositely to each other for folding a portion of the sheet deflecting from said buckle zone(s) (b1-b4);
a rotating shaft of at least one of the rollers of each of said roller pairs being carried by one end of a lever (6), said lever (6) being arranged for swing around a supporting point (8) provided at its intermediate position, the other end of said lever (6) being provided with a spring resiliently biasing said roller carried by said lever (6) in a direction in which said roller is pressed against the counter roller, said lever (6) being provided with a roller gap adjusting means for adjusting a gap between the rollers for each of said roller pairs by setting the closest position of the roller carried by the lever (6) to the counter roller,
said roller apparatus characterized in that said roller gap adjusting means comprises:
an adjustment rod (15a-15e) one end of which is brought into contact with said other end of said lever (6) or is pivotally connected to said other end of said lever (6) through a pivot;
a guide (14) for guiding said adjustment rod (15a-15e) in a direction of the axis thereof;
a pulse motor (M1-M5) connected to the other end of said adjustment rod (15a-15e) so as to move said adjustment rod (15a-15e) through said guide (14), said lever (6) being rotated around said supporting point (8) by rotary drive of said pulse motor (M1-M5);
an input means (18) for inputting a preset value of a gap length between the rollers for each of said roller pairs;
a storage means (17) for storing the preset value inputted from said input means (18); and
a control means (16) sending a control signal to the associated pulse motor (M1-M5) so as to drive said pulse motor (M1-M5) based on the preset value stored in said storage means (17),
whereby, for each of said roller pairs, said pulse motor (M1-M5) is driven by said control means (16), said adjustment rod (15a-15e) is moved so as to swing the lever (6) and the gap length between the opposed rollers is adjusted.

2. The roller apparatus for a sheet folding machine as claimed in claim 1, characterized in that said input means (18) comprises a touch panel display (20), and a screen of said touch panel display (20) is provided with a selector button (21) for selecting a roller gap to be adjusted, and a preset value input button (22a, 22b) for inputting or changing a preset value of the length of the roller gap selected by said selector button (21).

3. The roller apparatus for a sheet folding machine as claimed in claim 1, characterized in that said roller apparatus further comprises another input means (19) arranged separately from said roller apparatus and said another input means (19) is connected to said control means (16), said storage means (17) and said input means (18) of said roller apparatus for data communication, and the information about the roller gap selected by said another input means (19) and the preset value of the gap length of said roller gap inputted from said another input means (19) are directly transmitted to said storage means (17) and said input means (18).
